(19) United States
(12) Patent Application Publication
(10) Pub. No.: US 2024/0051235 A1
(43) Pub. Date: Feb. 15, 2024

(54) STOP SYSTEM FOR A TOOL FOR HEATING BY DIRECT CONTACT

(71) Applicant: PLASTIC OMNIUM ADVANCED INNOVATION AND RESEARCH, Bruxelles (BE)

(72) Inventors: Kourosh BAHRAMIAN, Bruxelles (BE); Alain POTIER, Bruxelles (BE)

(73) Assignee: PLASTIC OMNIUM ADVANCED INNOVATION AND RESEARCH, Bruxelles (BE)

(21) Appl. No.: 18/547,539

(22) PCT Filed: Mar. 2, 2022
(86) PCT No.: PCT/EP2022/055308

§ 371 Date: Aug. 23, 2023

(30) Foreign Application Priority Data
Mar. 3, 2021 (LU) LU102591

(51) Int. Cl. B29C 65/20; B29C 65/00

(52) U.S. Cl. CPC B29C 65/2061; B29C 66/53246; B29C 66/63; B29L 2031/7172

(57) ABSTRACT

A stop system intended to engage with a tool for heating by direct contact for a machine for plastic welding of a component over an opening in a wall of a motor vehicle tank. The system contains a cam mechanism which includes a straight cam with a longitudinal axis and a follower coupled to the straight cam for converting a translational movement along the longitudinal axis of the follower into a straight or quasi-straight movement of a point of the follower in a direction non-parallel to the longitudinal axis. The cam mechanism of the follower is capable of moving from a rest position, where the stop system is configured to pass freely through an opening in a wall of a motor vehicle tank, to a working position. The stop system is configured to bear against an inner surface of the wall of the tank through which the straight cam passes.

The present invention relates to a stop system that is intended to engage with a tool for heating by direct contact. More particularly, the invention relates to a stop system that is intended to engage with a tool for heating by direct contact for a machine for plastic welding of a component to an opening in a wall of a motor vehicle tank.

The invention also relates to an assembly for heating by direct contact.

In addition, the invention relates to a machine for plastic welding of a component.

The invention further also relates to an engagement method for the engagement of a stop system with a tool for heating by direct contact.

The invention likewise relates to a method for heating by direct contact.

Lastly, the invention relates to a method for plastic welding of a component.

It is known practice to use a tool for heating by direct contact, for example a hot plate, to soften and melt a portion of a first plastic component to which a second component is to be welded. The term “weld surface” refers to the portion of the first component that is heated by the tool for heating by direct contact in order to be softened and melted. When the first component is, for example, a hollow plastic body obtained by extrusion blow molding, for example a motor vehicle tank, and the second component is a component that passes through an opening made in a wall of the hollow plastic body, for example a solenoid valve, the tool for heating by direct contact must come into contact with the edge of the opening and apply contact pressure thereto.

A hollow plastic body obtained by extrusion blow molding is a thin-walled body in comparison with the same hollow plastic body obtained by injection molding. A thin wall is particularly sensitive to bending and deforms even more readily due to the wall having a large area. Therefore, the problem of applying contact pressure to the edge of the opening is the bending deformation thereof. Specifically, bending deformation of the edge of the opening during the heating thereof by the tool for heating by direct contact tends to separate the weld surface from the tool for heating by direct contact, leading to a non-uniform heating of the weld surface. Non-uniform heating of the weld surface can compromise the quality of the weld of the second component to the first component. When the first component is a motor vehicle tank and the second component is a component that passes through the tank such as, for example, a solenoid valve, poor quality of the weld of the second component to the first component increases the risk of the tank having a sealing defect.

The object of the invention is in particular to overcome the above-mentioned drawbacks by providing a stop system that ensures uniform heating of the weld surface of a component that is liable to deform by bending under the effect of a tool for heating by direct contact.

To that end, the invention relates to stop system intended to engage with a tool for heating by direct contact for a machine for plastic welding of a component to an opening in a wall of a motor vehicle tank, the system comprising a deployable member which comprises:
an extension element of longitudinal axis X selected from the following list: straight cam, rack, worm screw, inflatable balloon,
at least one follower coupled to the extension element for converting a translational movement along the longitudinal axis X of the at least one follower into a straight or quasi-straight movement of at least one point of the at least one follower in a direction that is not parallel to the longitudinal axis X, in which deployable member the at least one follower is capable of moving from a rest position in which the stop system is configured to pass freely through an opening in a wall of a motor vehicle tank to a working position in which the stop system is configured to bear against an inner surface of the wall of the tank through which the extension element passes, the inner surface being contiguous with the opening in the wall of the tank.

Thus, the stop system prevents the wall of the tank from deforming by bending when contact pressure is applied by the tool for heating by direct contact to the edge of the opening.

What is meant by “plastic welding” is a set of techniques used to weld two thermoplastic parts.

What is meant by “pass freely through” is passing through the wall of the tank without touching it.

What is meant by “straight cam” is that a segment of the cam, to which segment the at least one follower is coupled, is straight.

It will be recalled that a tank wall has an inner surface and an outer surface. The inner surface is the surface facing the space inside the tank while the outer surface is the surface facing the space outside the tank. Thus, the deployable member is located entirely in the space inside the tank once the stop system has passed through the opening in the tank wall and remains therein while said at least one follower goes from the rest position to the working position and vice versa.

What is meant by “straight or quasi-straight” is that the movement of at least one point of said at least one follower essentially describes a line segment and not a circular arc.

By virtue of the invention, each point of said at least one follower describes a straight segment in the space inside the tank when said at least one follower goes from the rest position to the working position. This makes it possible to go from the rest position to the working position in a single movement, this movement resulting just from the action of the deployable member. By virtue of this arrangement, the transition from the rest position to the working position is simplified and the time required for this transition is reduced.

According to additional features of the system according to the invention:
the bearing the stop system against the inner surface of the wall of the tank is selected from among flat bearing, linear bearing and point bearing. Flat bearing provides better support against the deformation of the tank wall when contact pressure is applied by the tool for heating by direct contact to the edge of the opening.
the extension element being a straight cam, the coupling of said at least one follower to the straight cam is achieved by direct contact between a first peripheral surface of said at least one follower and a planar coupling surface of the straight cam which is inclined at a non-zero angle A relative to the direction of the longitudinal axis X of the straight cam, such that the first peripheral surface of said at least one follower is made to follow the planar coupling surface of the straight cam, causing a translational movement along the longitudinal axis X of said at least one follower combined with a rotational movement of said at least one follower about an axis of rotation Y perpendicular to the longitudinal axis X when said at least one follower goes from the rest position to the working position. Thus, the straight or quasi-straight movement of at least one point of said at least one follower in a direction that is not parallel to the longitudinal axis X is the result of the combination of two interdependent movements: a translational movement of said at least one follower and a rotational movement of said at least one follower. The two movements are interdependent in that one cannot take place without the other.

What is meant by “direct contact” is contact with friction.
the first peripheral surface is a rounded surface. Thus, the friction is reduced.
the angle A is between 10° and 15°, and preferably the angle A is about 10°. The angle A is the angle formed between a straight line on the longitudinal axis X and the orthogonal projection thereof on a plane coincident with the planar coupling surface.
the extension element being a straight cam, a second peripheral surface of said at least one follower is configured to bear against the inner surface of the wall of the tank through which the straight cam passes, in the working position. Thus, the deformation of the wall of the tank is prevented by said at least one follower.
the bearing the second peripheral surface of said at least one follower against the inner surface of the wall of the tank is selected from among flat bearing, linear bearing and point bearing. Flat bearing provides better support against the deformation of the tank wall when contact pressure is applied by the tool for heating by direct contact to the edge of the opening.
the extension element being a straight cam, said at least one follower comprises a rotating shaft of axis Y mounted in a cavity in a cylindrical support of longitudinal axis X, the cylindrical support being capable of moving axially along the longitudinal axis X relative to the straight cam in order to convert the translational movement along the longitudinal axis X of said at least one follower into the straight or quasi-straight movement of at least one point of said at least one follower. By virtue of this arrangement, said at least one follower is dependent on the straight cam.

Advantageously, the follower is a non-deformable follower; in this case, the translational movement along the longitudinal axis X of said at least one follower is converted into a straight or quasi-straight movement of each point of said at least one follower. Those points of said at least one follower which are located on the axis Y move in a direction that is parallel to the longitudinal axis X while those points which are not located on the axis Y move linearly in a direction that is not parallel to the longitudinal axis X.
the deployable member comprises ‘n’ followers, where n is an increasing function of the size of the opening. Thus, the greater the size of the opening, the more followers are provided to support the wall of the tank against the deformation thereof when contact pressure is applied by the tool for heating by direct contact to the edge of the opening. Advantageously, the ‘n’ followers are arranged equidistantly over the inner surface of the wall adjacent to the edge of the opening.

Preferably, ‘n’ is greater than or equal to three. Thus, the bearing of the stop system against the inner surface of the wall of the tank is isostatic.

Preferably, ‘n’ is greater than or equal to four. Thus, the bearing of the stop system against the inner surface of the wall of the tank is hyperstatic.

The invention also relates to an assembly for heating by direct contact for a machine for plastic welding of a component to an opening in a wall of a motor vehicle tank, the assembly comprising a tool for heating by direct contact and the above-mentioned stop system. Thus, the heating assembly prevents the wall of the tank from deforming by bending during the heating of the weld surface.

According to additional features of the assembly for heating by direct contact according to the invention:
the tool for heating by direct contact comprises a melt overflow limiter. Thus, during the heating of the weld surface, the molten plastic material is prevented from flowing into the opening.
the melt overflow limiter is secured to the tool for heating by direct contact, for example by means of a clamping piece. Thus, the melt overflow limiter forms an assembly with the tool for heating by direct contact.

The invention also relates to a machine for plastic welding of a component to an opening in a wall of a motor vehicle tank, the machine comprising the above-mentioned heating assembly and a tool for attaching a component by plastic welding. Thus, the plastic welding machine improves the quality of the weld of the component to the tank.

The invention also relates to an engagement method for the engagement of the above-mentioned stop system with a tool for heating by direct contact for a machine for plastic welding of a component to an opening in a wall of a motor vehicle tank, the method comprising the following steps:
placing said at least one follower in the rest position,
passing the stop system through the opening,
bringing the tool for heating by direct contact into direct contact with an outer surface of the wall of the tank that is contiguous with the opening,
placing said at least one follower in the working position.

The outer surface of the wall of the tank that is contiguous with the opening is the weld surface. Thus, the engagement method prevents the contact pressure of the tool for heating by direct contact from deforming the wall of the tank.

According to additional features of the engagement method according to the invention:
the step of bringing the tool for heating by direct contact into direct contact with an outer surface of the wall of the tank that is contiguous with the opening is carried out before the step of placing said at least one follower in the working position. Thus, the heating of the weld surface is carried out as soon as possible, which reduces the time taken to produce a tank.
the step of bringing the tool for heating by direct contact into direct contact with an outer surface of the wall of the tank that is contiguous with the opening is carried out after the step of placing said at least one follower in the working position. Thus, the deformation of the wall is prevented from the start of heating.
the step of bringing the tool for heating by direct contact into direct contact with an outer surface of the wall of the tank that is contiguous with the opening is carried out simultaneously with the step of placing said at least one follower in the working position. Thus, the heating of the weld surface is carried out as soon as possible while still preventing the deformation of the wall from the start of heating.

The invention also relates to a method for heating a wall of a motor vehicle tank by direct contact using a tool for heating by direct contact, the method comprising the steps of the above-mentioned engagement method plus a step of heating the outer surface of the wall of the tank that is contiguous with the opening by direct contact using the tool for heating by direct contact. Thus, the method for heating by direct contact prevents the wall of the tank from deforming by bending during the heating of the weld surface by the tool for heating by direct contact.

Lastly, the invention relates to a method for plastic welding of a component to an opening in a wall of a motor vehicle tank, the method comprising the steps of the above-mentioned heating method plus the following steps:
placing said at least one follower in the rest position,
withdrawing the stop system from the opening,
disengaging the tool for heating by direct contact from the opening,
welding a component to the opening.

Thus, the plastic welding method improves the quality of the weld of the component to the tank.

### BRIEF DESCRIPTION OF THE FIGURES

The invention will be better understood from reading the following description, which is provided solely by way of example and with reference to the appended drawings, in which:

FIG. 1 is a partial perspective view of a plastic welding machine according to the invention,

FIGS. 2 to 5 are sectional views of a stop system according to the invention,

FIG. 6 is a sectional view of one variant embodiment of the stop system according to the invention.

### DETAILED DESCRIPTION

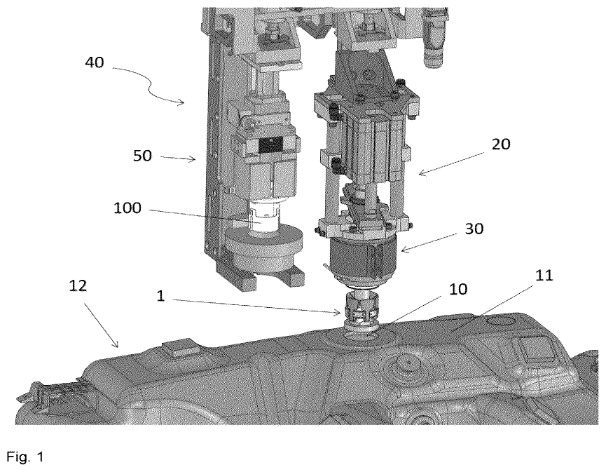

FIG. 1 illustrates a portion of a machine 40 for plastic welding of a component 100 to an opening 10 in a wall 11 of a tank 12 of a motor vehicle (not shown). The plastic welding machine 40 comprises a heating assembly 20 and a tool 50 for attaching the component 100 by plastic welding. The heating assembly 20 comprises a tool 30 for heating by direct contact and a stop system 1 according to the invention. The stop system 1 is in an initial position and is located entirely in the space outside the tank 12.

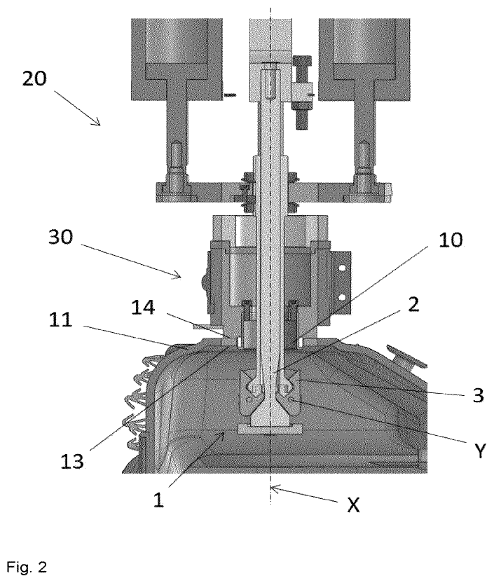

FIGS. 2 to 4 illustrate the stop system 1 in a final position in which the stop system 1 is entirely located in the volume inside the tank 12 and engages with the tool 30 for heating by direct contact.

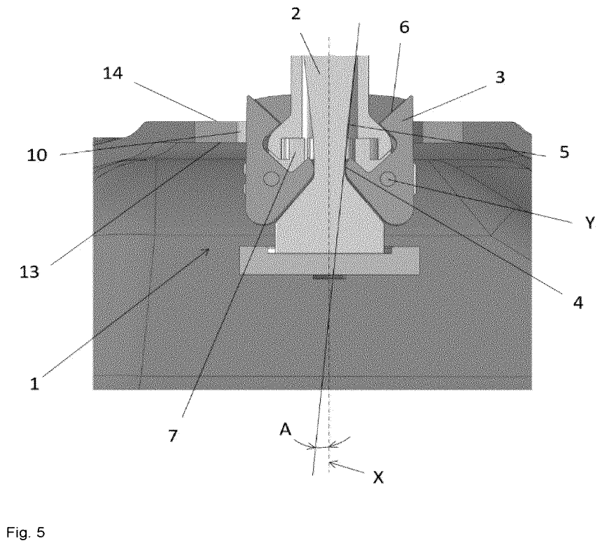

FIG. 5 illustrates the stop system 1 in an intermediate position between the initial position and the final position. In the intermediate position, the stop system 1 passes through the opening 10.

As illustrated in FIGS. 2 to 5, the stop system 1 comprises a deployable member comprising an extension element 2, in this case consisting of a straight cam 2, of longitudinal axis X and at least one follower 3 coupled to the straight cam 2 in order to convert a translational movement along the longitudinal axis X of said at least one follower 3 into a straight or quasi-straight movement of at least one point of said at least one follower 3 in a direction that is not parallel to the longitudinal axis X. The deployable member forms a cam mechanism in this case, i.e. a mechanism by which a movement of the cam beings about a different and reversible movement of the one or more followers coupled to the cam. The at least one follower 3 is capable of moving from a rest position in which the stop system 1 is configured to pass freely through the opening 10 in the wall 11 of the motor vehicle tank 12 to a working position in which the stop system 1 is configured to bear against an inner surface 13 of the wall 11 of the tank 12 through which the straight cam 2 passes, the inner surface 13 being contiguous with the opening 10.

Ideally, the coupling of said at least one follower 3 to the straight cam 2 is achieved by direct contact between a first peripheral surface 4 of said at least one follower 3 and a planar coupling surface 5 of the straight cam 2 which is inclined at a non-zero angle A relative to the direction of the longitudinal axis X of the straight cam 2, such that the first peripheral surface 4 of said at least one follower 3 is made to follow the planar coupling surface 5 of the straight cam 2, causing a translational movement along the longitudinal axis X of said at least one follower 3 combined with a rotational movement of said at least one follower 3 about an axis of rotation Y perpendicular to the longitudinal axis X when said at least one follower 3 goes from the rest position to the working position.

A second peripheral surface 6 of said at least one follower 3 is configured to bear against the inner surface 13 of the wall 11 of the tank 12 through which the straight cam 2 passes, in the working position.

Advantageously, said at least one follower 3 comprises a rotating shaft of axis Y mounted in a cavity in a cylindrical support 7 of longitudinal axis X (see FIG. 5), the cylindrical support 7 being capable of moving axially along the longitudinal axis X relative to the straight cam 2 in order to convert the translational movement along the longitudinal axis X of said at least one follower 3 into the straight or quasi-straight movement of at least one point of said at least one follower 3.

Preferably, the deployable member comprises ‘n’ followers 3, where n is an increasing function of the size of the opening. In the example illustrated, ‘n’ is six.

Advantageously, the six followers 3 are arranged equidistantly over the inner surface 13 of the wall 11 adjacent to the edge of the opening 10.

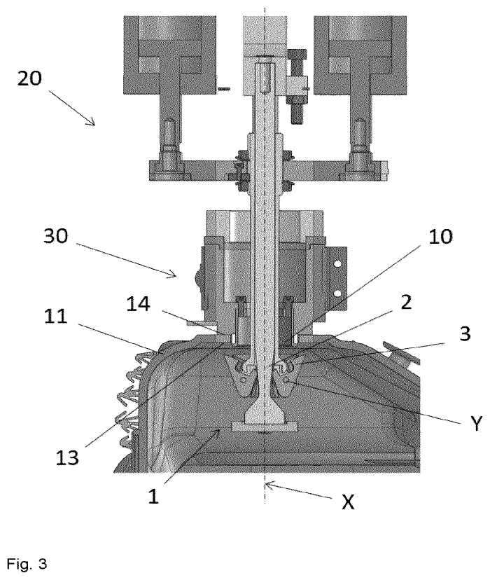

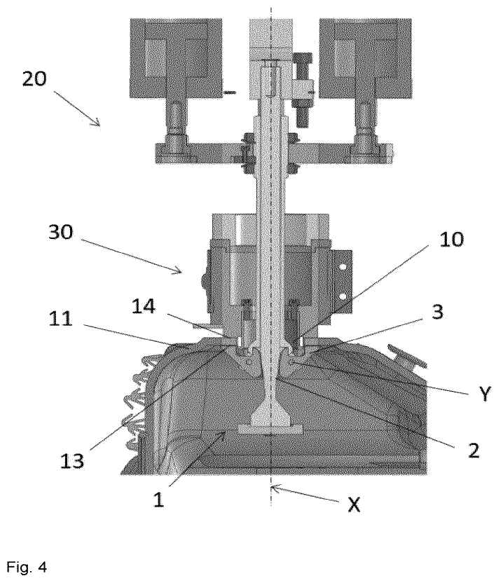

FIGS. 1 to 5 also illustrate an engagement method for the engagement of the stop system 1 with the tool 30 for heating by direct contact. The engagement method comprises the following steps:
placing said at least one follower 3 in the rest position (see FIG. 1),
passing the stop system 1 through the opening 10 (see FIG. 5),
bringing the tool 30 for heating by direct contact into direct contact with an outer surface 14 of the wall 11 of the tank 12 that is contiguous with the opening 10 (see FIG. 2),
placing said at least one follower 3 in the working position (see FIG. 4). FIG. 3 illustrates an intermediate position of said at least one follower 3 during the transition from the rest position to the working position.

Preferably, the step of bringing the tool 30 for heating by direct contact into direct contact with an outer surface 14 of the wall 11 of the tank 12 that is contiguous with the opening 10 is carried out before the step of placing said at least one follower 3 in the working position.

FIGS. 1 to 5 also illustrate a method for heating by direct contact comprising the steps of the above-mentioned engagement method plus a step of heating the outer surface 14 of the wall 11 of the tank 12 that is contiguous with the opening 10 by direct contact using the tool for heating by direct contact 30.

Lastly, FIGS. 1 to 5 illustrate a plastic welding method comprising the steps of the above-mentioned heating method plus the following steps:
placing said at least one follower 3 in the rest position,
withdrawing the stop system 1 from the opening 10,
disengaging the tool 30 for heating by direct contact from the opening 10,
welding a component 100 to the opening 10.

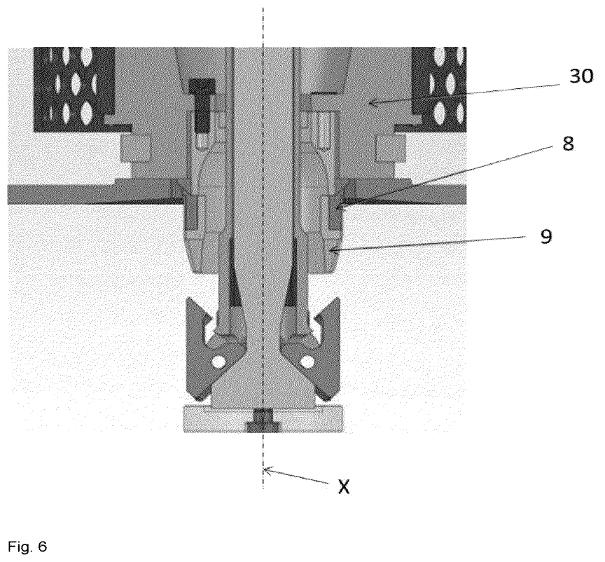

FIG. 6 illustrates a variant embodiment in which the tool for heating by direct contact 30 comprises a melt overflow limiter 8.

Ideally, the melt overflow limiter 8 is secured to the tool 30 for heating by direct contact, for example by means of a clamping piece 9.

According to variant embodiments of the invention, the straight cam of the deployable member is replaced with one of the elements from the following list: rack, worm screw, inflatable balloon. The operation of the stop system remains similar to that described above.

### LIST OF REFERENCES

1: stop system,
2: extension element/straight cam,
3: follower,
4: first peripheral surface of a follower
5: planar coupling surface of the straight cam
6: second peripheral surface of a follower
7: cylindrical support
8: melt overflow limiter
9: clamping piece
10: opening in a wall of a motor vehicle tank,
11: wall of a motor vehicle tank,
12: motor vehicle tank,
13: inner surface of the wall of the tank through which the straight cam passes,
14: outer surface of the wall of the tank through which the straight cam passes,
20: assembly for heating by direct contact
30: tool for heating by direct contact
40: plastic welding machine
50: tool for attaching a component
100: component to be welded

1: A stop system intended to engage with a tool for heating by direct contact for a machine for plastic welding of a component to an opening in a wall of a motor vehicle tank, the system comprising a deployable member which comprises:
an extension element of longitudinal axis X selected from the group consisting of a straight cam, a rack, a worm screw, and an inflatable balloon,
at least one follower coupled to the extension element for converting a translational movement along the longitudinal axis X of the at least one follower into a straight or quasi-straight movement of at least one point of the at least one follower in a direction that is not parallel to the longitudinal axis X,
wherein the deployable member of the at least one follower is capable of moving from a rest position in which the stop system is configured to pass freely through an opening in a wall of a motor vehicle tank to a working position in which the stop system is configured to bear against an inner surface of the wall of the tank through which the extension element passes,
wherein the inner surface is contiguous with the opening.

2: The stop system according to claim 1,
wherein, the extension element is a straight cam, a coupling of said at least one follower to the straight cam is achieved by direct contact between a first peripheral surface of said at least one follower and a planar coupling surface of the straight cam, which is inclined at a non-zero angle A relative to the direction of the longitudinal axis X of the straight cam, such that the first peripheral surface of said at least one follower is made to follow the planar coupling surface of the straight cam, causing a translational movement along the longitudinal axis X of said at least one follower combined with a rotational movement of said at least one follower about an axis of rotation Y perpendicular to the longitudinal axis X when said at least one follower goes from the rest position to the working position.

3: The stop system according to claim 1,
wherein the extension element is a straight cam, a second peripheral surface of said at least one follower is configured to bear against the inner surface of the wall of the tank through which the straight cam passes, in the working position.

4: The stop system according to claim 1,
wherein the extension element is a straight cam, said at least one follower comprises a rotating shaft of axis Y mounted in a cavity in a cylindrical support of the longitudinal axis X, the cylindrical support being capable of moving axially along the longitudinal axis X relative to the straight cam in order to convert the translational movement along the longitudinal axis X of said at least one follower into the straight or quasi-straight movement of at least one point of said at least one follower.

5: The stop system according to claim 1,
wherein the deployable member comprises ‘n’ followers, where n is an increasing function of the size of the opening.

6: An assembly for heating by direct contact for a machine for plastic welding of a component to an opening in a wall of a motor vehicle tank, the assembly comprising a tool for heating by direct contact and a stop system according to claim 1.

7: The assembly for heating according to claim 6, wherein the tool for heating by direct contact comprises a melt overflow limiter.

8: The assembly for heating according to claim 7, wherein the melt overflow limiter is secured to the tool for heating by direct contact.

9: A machine for plastic welding of a component to an opening in a wall of a motor vehicle tank, the machine comprising a heating assembly according to claim 6 and a tool for attaching a component by plastic welding.

10: An engagement method for the engagement of a stop system as according to claim 1 with a tool for heating by direct contact for a machine for plastic welding of a component to an opening in a wall of a motor vehicle tank, the method comprising:
placing said at least one follower in the rest position,
passing the stop system through the opening,
bringing the tool for heating by direct contact into direct contact with an outer surface of the wall of the tank that is contiguous with the opening, and
placing said at least one follower in the working position.

11: The engagement method according to claim 10, wherein the bringing the tool for heating by direct contact into direct contact with an outer surface of the wall of the tank that is contiguous with the opening is carried out before the placing said at least one follower in the working position.

12: A method for heating a wall of a motor vehicle tank by direct contact using a tool for heating by direct contact, the method comprising
performing the engagement method according to claim 10, and
heating the outer surface of the wall of the tank that is contiguous with the opening by direct contact using the tool for heating by direct contact.

13: A method for plastic welding of a component to an opening in a wall of a motor vehicle tank, the method comprising:
heating a wall of a motor vehicle tank by performing the method of claim 12, and
performing the successive steps,
placing said at least one follower in the rest position,
withdrawing the stop system from the opening,
disengaging the tool for heating by direct contact from the opening, and
welding a component to the opening.
